(19) United States
(12) Patent Application Publication
(10) Pub. No.: US 2023/0340679 A1
(43) Pub. Date: Oct. 26, 2023

(54) COBALT-COATED ELECTRODES

(71) Applicant: Wichita State University, Wichita, KS (US)

(72) Inventors: Shuang GU, Wichita, KS (US); Nguon Kien HA, Wichita, KS (US)

(21) Appl. No.: 18/304,149

(22) Filed: Apr. 20, 2023

Related U.S. Application Data
(60) Provisional application No. 63/332,738, filed on Apr. 20, 2022.

(51) Int. Cl. C25B 11/075; C25B 1/27; C25B 11/052; C25B 11/056; C25B 11/061; C25B 11/042; C25B 11/03

(52) U.S. Cl. CPC C25B 11/075; C25B 1/27; C25B 11/052; C25B 11/056; C25B 11/061; C25B 11/042; C25B 11/03; C25D 3/12

(57) ABSTRACT

Processes for converting nitrate to ammonia are described. Nitrate is electrochemically converted in the presence of a catalyst to form a product comprising ammonia. The catalyst comprises cobalt on a support, where the support is in the form of a foil, mesh, cloth, gauze, sponge, and combinations thereof. The catalyst may alternatively comprise a cobalt in the form of a foil, mesh, cloth, gauze, sponge, and combinations thereof.

### CROSS-REFERENCE TO RELATED APPLICATIONS

This application claims priority to U.S. Provisional Patent Application No. 63/332,738, filed Apr. 20, 2022, the entire disclosure of which is incorporated herein by reference.

### STATEMENT REGARDING FEDERALLY SPONSORED RESEARCH OR DEVELOPMENT

This invention was made with government support under NSF Award #2036944 awarded by NSF Agency/Future Manufacturing Program. The government has certain rights in the invention.

### FIELD

Provided herein are methods for electrochemically converting nitrate in the presence of a cobalt catalyst or electrode to form a product comprising ammonia. Also provided herein are methods for preparing the cobalt catalyst or electrode.

### BACKGROUND

Nitrate is a harmful chemical, widely found in surface and ground waters. Nitrate pollution is largely caused by anthropogenic activities, such as excessive use of nitrogen-rich fertilizers, and can be found in wastewater discharges from municipal and industrial sources. Nitrate contamination has been associated with some human health issues and detrimental environmental problems. For example, consuming excess nitrate can induce methemoglobinemia, birth defects, digestive problems, and cancers. Nitrate is also responsible for the vast eutrophication, hypoxia, and harmful algal bloom problems experienced in natural waters, which damage the ecosystem significantly.

Waste nitrate can be removed from streams by various methods such as ion exchange, reverse osmosis, electrodialysis, and biological denitrification (BD). Waste nitrate may also be collected and concentrated to serve as an inexpensive chemical precursor for the synthesis of valuable chemical products. For example, nitrate can be converted to ammonia (NH₃), which is widely used in agriculture fertilization.

Therefore, there remains a need for improved and more efficient processes for the conversion of nitrate into less harmful and more useful products such as ammonia.

### BRIEF SUMMARY

One embodiment of the present invention is directed to a process for converting nitrate to ammonia. The process comprises electrochemically converting nitrate in the presence of a catalyst to form a product comprising ammonia. The catalyst comprises cobalt on a support. The support comprises a metal and is in a form selected from the group consisting of a foil, mesh, cloth, gauze, sponge, and combinations thereof.

Other embodiments of the present invention are directed to processes for converting nitrate to ammonia comprising electrochemically converting nitrate in the presence of a catalyst to form a product comprising ammonia. The catalyst comprises cobalt in a form selected from the group consisting of a foil, mesh, cloth, gauze, sponge, and combinations thereof.

Other objects and features will be in part apparent and in part pointed out hereinafter.

### BRIEF DESCRIPTION OF THE FIGURES

FIG. 1A illustrates the current density versus electrolysis time for various metals.

FIG. 1B illustrates the ammonia-producing current density and coulombic efficiency for various metals in a nitrate to ammonium process.

FIG. 1C illustrates the nitrite-producing current density and coulombic efficiency for various metals in a nitrate to ammonium process.

FIG. 2 is a volcano plot correlating the ammonia current density and metal-nitrogen binding strength of various metals.

FIG. 3A reports the ammonia-producing current density and coulombic efficiency of the process of Example 1.

FIG. 3B reports the nitrate-producing current density and coulombic efficiency of the process of Example 1.

FIG. 4 sets forth the current-time profiles of certain samples of Table 6 of Example 4.

FIG. 5 sets forth the current-time profiles of certain samples of Table 7 of Example 4.

### DETAILED DESCRIPTION

Nitrate (NO₃⁻) contamination can be typically found in the surface and groundwater, and is known to cause detrimental effects on both human health and environment. For example, consuming excess nitrate can induce methemoglobinemia, birth defect, digestive problems, and cancers.

However, nitrate is capable of being electrochemically converted to a product comprising ammonia. Ammonia is widely used in agriculture and other industries, and thus conversion of a harmful contaminant such as nitrate into a more useful product such as ammonia is a desirable goal.

The electrochemical conversion of nitrate to ammonia (referred to herein as nitrate-to-ammonia) allows for the creation of a product that has wide applications and also represents an overall reduction in the carbon footprint associated with producing ammonia. Producing ammonia from nitrate can directly replace the traditional manufacturing of ammonia from natural gas, which consumes significant amounts of energy and releases vast amount of greenhouse gases.

The electrode reaction of nitrate to ammonia and its reversible electrode potentials are as follows:

NO₃⁻+6H₂O+8e⁻=NH₃+9OH⁻

E°(NO₃⁻/NH₃)=−0.133 V vs. SHE (at pH 14)=+0.695 V vs. RHE (at pH 14)

E°(NO₃⁻/NH₃)=−0.066 V vs. SHE (at pH 13)=+0.703 V vs. RHE (at pH 13)

The electrochemical conversion of nitrate to ammonia comprises the application of potential to a subject sample and is typically aided by the presence of a catalyst or catalytic electrode. Several previous catalytic systems have been reported to electrochemically convert nitrate to ammonia. The catalysts from those reports were based on pure metallic conversion surfaces such as Cu, Ni, Pb, Ag, Zn, C, and Fe; alloys such as Ru—O systems, Cu—Ni alloys, or Ag—Ni alloys; or metal-phthalocyanine (Pc) complexes such as FePc, NiPc, CoPc, and CuPc.

The inventors of the present disclosure have discovered that the choice of catalytic metal and the structure of catalysts (e.g., the support materials upon which the catalytic metal is deposited) play a crucial role in the electrochemical conversion of nitrate to ammonia.

The present invention is generally directed to catalysts that contain cobalt-coated supports, cobalt-coated metal supports, or more generally comprise cobalt in an increased surface area configuration (e.g., a foil, mesh, etc.). These catalysts serve as a new family of electrodes for the electrochemical conversion of nitrate to ammonia. In other embodiments, the present invention is further directed to processes for electrochemically converting nitrate in the presence of a cobalt-containing catalyst on a support to form a product comprising ammonia.

Although reference is made herein to a cobalt catalyst, it will be understood that the system and processes are equally applicable to a cobalt containing electrode or a catalyst material functioning as an electrode in an electrochemical conversion process.

As shown below in Table 1, exemplary cobalt containing catalysts of the present invention (i.e. the first three catalysts) exhibited a significant improvement in the conversion of nitrate to ammonia as compared to previously known catalysts. In situations where the overall conversion of the cobalt catalyst of the present invention was comparable to those previously know, the catalysts of the present invention represented a significant commercial improvement by using less expensive catalyst metals. For example, a Ru—O catalyst is significantly more expensive than the Co catalyst of the present invention.

TABLE 1
Comparison of nitrate-to-ammonia performance among catalysts

| | | | | | | Total | NH₃ | |
|---|---|---|---|---|---|---|---|---|
| | | | Conc. | | | current | current | |
| | | | of | | Potential | density | density | CE |
| | Preparation | Alkaline | NO₃⁻ | | vs. RHE | (mA | (mA | towards |
| Catalyst | method | media | (M) | pH | (V) | cm⁻²) | cm⁻²) | to NH₃ |
| Plated- | Electroplating of | 0.1M KOH | 0.5 | 13 | −0.30 | 188 | 169 | 90% |
| Co/SS | Co on SS | | | | | | | |
| Sprayed- | Air-spraying of Co | 0.1M KOH | 0.5 | 13 | −0.30 | 102 | 92 | 90% |
| Co/SS | nanoparticles on | | | | | | | |
| | SS | | | | | | | |
| Co foil | Pure | 0.1M KOH | 0.1 | 13 | −0.50 | 37 | 32 | 86% |
| Ru—O | Strained | 1M KOH | 1 | 14 | −0.20 | 120.00 | 120.00 | 100.0% |
| | nanoclusters | | | | | | | |
| Cu₅₀Ni₅₀ | Electrodeposition | 1M KOH | 0.1 | 14 | −0.15 | 80.00 | 79.20 | 99.0% |
| Ag₂₇Ni₇₃ | Electrodeposition | 1M NaOH | 0.02 | 14 | −0.23 | 38.70 | 35.02 | 90.5% |
| Ni | Pure | 1M NaOH | 0.02 | 14 | −0.23 | 35.10 | 28.61 | 81.5% |
| Ag₂₇Ni₇₃ | Electrodeposition | 1M NaOH | 0.02 | 14 | −0.23 | 25.80 | 21.41 | 83.0% |
| Cu | Electrodeposition | 1M NaOH | 0.02 | 14 | −0.43 | 9.26 | 7.86 | 84.9% |
| Cu₈₀Ni₂₀ | Electrodeposition | 1M NaOH | 0.02 | 14 | −0.23 | 10.65 | 7.86 | 73.8% |
| Cu | | 0.1M KOH | 0.05 | 13 | −0.39 | 5.50 | 4.62 | 84.0% |
| Cu₈₀Ni₂₀ | Electrodeposition | 1M NaOH | 0.02 | 14 | −0.03 | 5.15 | 4.38 | 85.0% |
| Pb | Pure | 3M NaOH & | 0.065 | 14.5 | −0.90 | 52.00 | 4.00 | 7.7% |
| | | 0.25M | | | | | | |
| | | Na₂CO₃ | | | | | | |
| CuPc-GCE | Coating MPc | 0.1M KOH | 0.1 | 13 | −0.53 | 6.00 | 3.84 | 64.0% |
| Cu | Electrodeposition | 1M NaOH | 0.02 | 14 | −0.23 | 2.49 | 1.52 | 61.0% |
| Ag | Pure | 1M NaOH | 0.02 | 14 | −0.23 | 3.52 | 0.71 | 20.3% |
| Ni | Electrodeposition | 1M NaOH | 0.02 | 14 | −0.23 | 0.58 | 0.27 | 46.3% |
| Cu | Electrodeposition | 1M NaOH | 0.02 | 14 | −0.03 | 0.09 | 0.03 | 32.8% |
| GCE | Coating MPc | 0.1M KOH | 0.1 | 13 | −0.53 | N/A | N/A | 99.0% |
| Zn | Pure | 3M NaOH & | 0.065 | 14.5 | −0.40 | N/A | N/A | 87.0% |
| | | 0.25M | | | | | | |
| | | Na₂CO₃ | | | | | | |
| NiPc-GCE | Coating MPc | 0.1M KOH | 0.1 | 13 | −0.33 | N/A | N/A | 85.0% |
| CoPc-GCE | Coating MPc | 0.1M KOH | 0.1 | 13 | −0.43 | N/A | N/A | 80.0% |
| FePc | | 3M NaOH & | 0.065 | 14.5 | −0.40 | N/A | N/A | 55.0% |
| | | 0.25M | | | | | | |
| | | Na₂CO₃ | | | | | | |
| FePc-GCE | Coating MPc | 0.1M KOH | 0.1 | 13 | −0.53 | N/A | N/A | 55.0% |
| Pb | Pure | 3M NaOH & | 0.065 | 14.5 | −1.00 | N/A | N/A | 23.0% |
| | | 0.25M | | | | | | |
| | | Na₂CO₃ | | | | | | |
| Fe | Pure | 3M NaOH & | 0.065 | 14.5 | −0.40 | N/A | N/A | 7.9% |
| | | 0.25M | | | | | | |
| | | Na₂CO₃ | | | | | | |
| Ni | Sintering | 3M NaOH & | 0.065 | 14.5 | −0.40 | N/A | N/A | 20.0% |
| | | 0.25M | | | | | | |
| | | Na₂CO₃ | | | | | | |

In certain embodiments, the support material may comprise a metal selected from the group consisting of stainless steel, nickel, copper, a Ni—Cu alloy, titanium, and combinations thereof. In one embodiment, the support comprises stainless steel. In another embodiment, the support comprises a Ni—Cu alloy (e.g., the Ni—Cu alloy Monel 400).

In some embodiments, the configuration of the support is selected such that the active surface area of the cobalt deposited thereon is maximized. In various embodiments, the support is in a form selected from the group consisting of a foil, mesh, cloth, gauze, sponge, and combinations thereof. For example, the support may be a metal foil, mesh, cloth, gauze, sponge, or combinations thereof.

Although certain metal support materials are referenced herein, it will be understood that any other suitable support which provides the required surface area for cobalt deposition and/or cost reduction may be utilized.

In an alternative embodiment, the present invention may be directed to a cobalt catalyst not containing a support, wherein the cobalt catalyst is configured to have an active surface area that is maximized. For example, the cobalt catalyst without a support may be in a form selected from the group consisting of a foil, mesh, cloth, gauze, sponge, and combinations thereof. In some embodiments, the cobalt catalyst without a support may be a pure cobalt catalyst (wherein “pure” indicates a catalyst comprising about 90% or greater, about 92% or greater, about 94% or greater, about 96% or greater, about 98% or greater, about 99% or greater, or about 99.5% or greater cobalt).

In certain embodiments, the support may have a mesh count of from about 20 to about 1,000 per inch, from about 20 to about 900 per inch, from about 20 to about 800 per inch, from about 20 to about 700 per inch, from about 20 to about 600 per inch, from about 20 to about 500 per inch, from about 20 to about 400 per inch, from about 30 to about 400 per inch, from about 40 to about 400 per inch, from about 50 to about 400 per inch, from about 60 to about 400 per inch, from about 60 to about 300 per inch, or from about 60 to about 200 per inch.

In one embodiment, the support is selected from the group consisting of stainless steel meshes 304, 316, 430, and combinations thereof.

In other embodiments, wherein the catalyst is a cobalt catalyst not containing a support, the catalyst may be in the form of a mesh, foil, cloth, gauze, sponge, or combinations thereof and have a mesh count of from about 20 to about 1,000 per inch, from about 20 to about 900 per inch, from about 20 to about 800 per inch, from about 20 to about 700 per inch, from about 20 to about 600 per inch, from about 20 to about 500 per inch, from about 20 to about 400 per inch, from about 30 to about 400 per inch, from about 40 to about 400 per inch, from about 50 to about 400 per inch, from about 60 to about 400 per inch, from about 60 to about 300 per inch, or from about 60 to about 200 per inch.

The catalyst comprising cobalt on a support may be prepared by any suitable process for deposition of cobalt on a support. In certain embodiments, the cobalt is deposited on the support using a method selected from the group consisting of electroplating, electrodeposition, chemical plating, air-spraying, solution-brushing, sintering of microparticles or nanoparticles, and combinations thereof. In one embodiment, the catalyst is prepared by electroplating. In another embodiment, the catalyst is prepared by chemical plating.

Exemplary plating processes are set forth in Example 2 below. For example, in one embodiment, the plating process comprises plating at room temperature (20-25° C.) using a plating solution, a plating substrate (catalyst support), a working electrode, a counter electrode, and a reference electrode. In one embodiment, the potential range, reported as voltage vs. the reference electrode, may be from −0.6 to −1.7, from −0.6 to −1.5, from −0.6 to −1.3, or from −0.9 to −1.5. The potential increment may be, for example, about 25 mV, about 50 mV, about 75 mV, or about 100 mV. The potential duration may be, for example, about 10 seconds, about 15 seconds, about 20 seconds, about 25 seconds, about 30 seconds, about 35 seconds, about 40 seconds, about 45 seconds, about 50 seconds, about 55 seconds, or about 60 seconds.

In some embodiments, cobalt may be deposited on the support by an air spraying process. For example, the process may comprise spraying a composition comprising cobalt particles onto the support. The particles may be cobalt microparticles, cobalt nanoparticles, or other cobalt particles. In one embodiment, the cobalt particles have an average particle size of about 25 nm, about 26 nm, about 27 nm, about 28 nm, about 29 nm, or about 30 nm.

In various embodiments, the composition that is deposited on the support comprises cobalt particles, an ionomer, and an alcohol. For example, the process may comprise depositing a composition comprising cobalt nanoparticles, Nafion, and isopropanol onto a support. Another embodiment comprises depositing a composition comprising cobalt nanoparticles, Nafion, and ethanol onto a support. In still further embodiments, the composition may comprise a balance of water. For example, a composition comprising cobalt particles, an ionomer, an alcohol, and the balance water.

In certain embodiments, the composition that is deposited on the support comprises about 0.01 wt % or greater, about 0.02 wt % or greater, about 0.03 wt % or greater, about 0.04 wt % or greater, about 0.05 wt % or greater, about 0.1 wt % or greater, about 0.2 wt % or greater, about 0.3 wt % or greater, about 0.4 wt % or greater, or about 0.5 wt % or greater of cobalt. In another embodiment, the composition that is deposited on the support comprises about 0.5 wt % or less, 0.4 wt % or less, 0.3 wt % or less, 0.2 wt % or less, 0.1 wt % or less, 0.05 wt % or less, 0.04 wt % or less, 0.03 wt % or less, 0.02 wt % or less, or 0.01 wt % or less of cobalt.

In some embodiments, the composition that is deposited on the support comprises about 5 wt % or greater, about 6 wt % or greater, about 7 wt % or greater, about 8 wt % or greater, about 9 wt % or greater, about 10 wt % or greater, about 11 wt % or greater, about 12 wt % or greater, about 13 wt % or greater, about 14 wt % or greater, or about 15 wt % or greater of an ionomer. In further embodiments, the composition that is deposited on the support comprises about 15 wt % or less, about 14 wt % or less, about 13 wt % or less, about 12 wt % or less, about 11 wt % or less, about 10 wt % or less, about 9 wt % or less, about 8 wt % or less, about 7 wt % or less, about 6 wt % or less, or about 5 wt % or less of an ionomer.

In certain embodiments, the composition that is deposited on the support comprises about 25 wt % or greater, about 30 wt % or greater, about 35 wt % or greater, about 40 wt % or greater, about 45 wt % or greater, or about 50 wt % or greater of an alcohol. In other embodiments, the composition that is deposited on the support comprises about 50 wt % or less, about 45 wt % or less, about 40 wt % or less, about 35 wt % or less, about 30 wt % or less, or about 25 wt % or less of an alcohol.

In various embodiments, the composition that is deposited on the support comprises about 25 wt % or greater, about 30 wt % or greater, about 35 wt % or greater, about 40 wt % or greater, about 45 wt % or greater, or about 50 wt % or greater of water. In other embodiments, the composition that is deposited on the support comprises about 50 wt % or less, about 45 wt % or less, about 40 wt % or less, about 35 wt % or less, about 30 wt % or less, or about 25 wt % or less of water.

In certain embodiments, the catalyst comprising cobalt has a cobalt loading of about 25 mg/cm² or less, about 20 mg/cm² or less, about 15 mg/cm² or less, about 10 mg/cm² or less, about 9 mg/cm² or less, about 8 mg/cm² or less, about 7 mg/cm² or less, about 6 mg/cm² or less, or about 5 mg/cm² or less. In various embodiments, the catalyst comprising cobalt has a cobalt loading of from about 0.75 mg/cm² to about 25 mg/cm², from about 0.75 mg/cm² to about 20 mg/cm², from about 0.75 mg/cm² to about 15 mg/cm², from about 0.75 mg/cm² to about 10 mg/cm², from about 0.8 mg/cm² to about 10 mg/cm², from about 0.85 mg/cm² to about 10 mg/cm², from about 0.9 mg/cm² to about 10 mg/cm², from about 1 mg/cm² to about 10 mg/cm², from about 1 mg/cm² to about 9.5 mg/cm², from about 1 mg/cm² to about 9 mg/cm², from about 1 mg/cm² to about 8.5 mg/cm², from about 1 mg/cm² to about 8 mg/cm², from about 1 mg/cm² to about 7.5 mg/cm², from about 1 mg/cm² to about 7 mg/cm², from about 1 mg/cm² to about 6.5 mg/cm², from about 1 mg/cm² to about 6 mg/cm², from about 1 mg/cm² to about 5.5 mg/cm², from about 1.5 mg/cm² to about 5.5 mg/cm², from about 2 mg/cm² to about 5.5 mg/cm², from about 2.5 mg/cm² to about 5.5 mg/cm², from about 2.5 mg/cm² to about 5 mg/cm², or from about 2.5 mg/cm² to about 4.5 mg/cm².

The catalysts described herein may be used in a process for electrochemically converting nitrate in the presence of the catalyst to form a product comprising ammonia. Other by-products may be present in the product of the electrochemical process, such as nitrite. In one embodiment, the process achieves a relatively high conversion to ammonia, with little to no undesirable by-products. For example, a conversion to ammonia of about 90% or greater and a conversion to nitrite of about 1% or less.

The electrochemical process may comprise a system containing an electrolytic solution, a working electrode, a counter electrode, a reference electrode, and the application of potential energy. The cobalt containing catalysts of the present invention may be utilized as the working electrode. The counter electrode may be, for example, an electrode comprising platinum, nickel, titanium, iridium, or combinations thereof. The counter electrode may optionally be in the form of a foil, mesh, cloth, gauze, sponge, or combinations thereof. The reference electrode may comprise any material suitable for use as a reference electrode in an electrochemical conversion operation. In certain embodiments, the reference electrode may be selected from the group consisting of Ag/AgCl, a saturated calomel electrode, a saturated mercury-mercurous sulphate electrode, and a reversible hydrogen electrode. In one embodiment, the reference electrode may be an Ag/Ag electrode used for potential control.

The nitrate to be converted may be present in an electrolytic composition. For example, in one embodiment, the nitrate is present in a composition comprising KOH, KNO₃, or a combination thereof. In another embodiment, the nitrate is present in a composition comprising KOH and KNO₃.

In certain embodiments, the working electrode and the counter electrode may be from about 5 cm to about 0.05 cm, from about 4 cm to about 0.05 cm, from about 3 cm to about 0.05 cm, from about 2 cm to about 0.05 cm, from about 2 cm to about 0.1 cm, from about 2 cm to about 0.2 cm, from about 2 cm to about 0.3 cm, from about 2 cm to about 0.4 cm, or from about 2 cm to about 0.5 cm apart. In other embodiments, the working electrode and the reference electrode may be from about 5 cm to about 0.05 cm, from about 4 cm to about 0.05 cm, from about 3 cm to about 0.05 cm, from about 2 cm to about 0.05 cm, from about 2 cm to about 0.1 cm, from about 2 cm to about 0.2 cm, from about 2 cm to about 0.3 cm, from about 2 cm to about 0.4 cm, or from about 2 cm to about 0.5 cm apart.

The current activity on the cobalt surface generally increase as the voltage rises. In some embodiments, the potential range of the conversion process is from about −0.2 V to about −2 V, from about −0.2 V to about −1.5 V, from about −0.2 V to about −1 V, from about −0.2 V to about −0.8 V, from about −0.3 V to about −0.8 V, from about −0.4 V to about −0.8 V, from about −0.5 V to about −0.8 V, or from about −0.6 V to about −0.8 V vs. RHE. In certain embodiments, the potential range of the present invention is from about −0.2 V to about −0.5 V vs. RHE. In another embodiment, the the potential of the present invention is about −0.3 V vs. RHE.

The process may comprise the application of potential to the system for about 1 minute or greater, about 2 minutes or greater, about 3 minutes or greater, about 4 minutes or greater, about 5 minutes or greater, about 10 minutes or greater, about 20 minutes or greater, about 30 minutes or greater, about 40 minutes or greater, about 50 minutes or greater, or about 1 hour or greater. In certain embodiments, the process comprises the application of a constant potential for about 1 minute or greater, about 2 minutes or greater, about 3 minutes or greater, about 4 minutes or greater, about 5 minutes or greater, about 10 minutes or greater, about 20 minutes or greater, about 30 minutes or greater, about 40 minutes or greater, about 50 minutes or greater, or about 1 hour or greater.

In certain embodiments, the process comprises a total current density of from about 30 mA/cm² to about 300 mA/cm², from about 30 mA/cm² to about 250 mA/cm², from about 30 mA/cm² to about 200 mA/cm², from about 30 mA/cm² to about 190 mA/cm², from about 30 mA/cm² to about 180 mA/cm², from about 30 mA/cm² to about 170 mA/cm², from about 30 mA/cm² to about 160 mA/cm², from about 30 mA/cm² to about 150 mA/cm², from about 30 mA/cm² to about 140 mA/cm², from about 30 mA/cm² to about 130 mA/cm², from about 30 mA/cm² to about 120 mA/cm², from about 30 mA/cm² to about 110 mA/cm², from about 30 mA/cm² to about 100 mA/cm². For example, the process may comprise a total current density as noted above at a potential vs. RHE of from about −0.2 V to about −2 V, from about −0.2 V to about −1.5 V, from about −0.2 V to about −1 V, from about −0.2 V to about −0.8 V, from about −0.3 V to about −0.8 V, from about −0.4 V to about −0.8 V, from about −0.5 V to about −0.8 V, or from about −0.6 V to about −0.8 V. In other embodiments, the process may comprise a total current density as noted above at a potential vs. RHE of about −0.2 or less, about −0.4 or less, about −0.6 or less, about −0.8 or less, or about −1 or less.

In some embodiments, the process comprises an ammonia producing current density of from about 30 mA/cm² to about 300 mA/cm², from about 30 mA/cm² to about 250 mA/cm², from about 30 mA/cm² to about 200 mA/cm², from about 30 mA/cm² to about 190 mA/cm², from about 30 mA/cm² to about 180 mA/cm², from about 30 mA/cm² to about 170 mA/cm², from about 30 mA/cm² to about 160 mA/cm², from about 30 mA/cm² to about 150 mA/cm², from about 30 mA/cm² to about 140 mA/cm², from about 30 mA/cm² to about 130 mA/cm², from about 30 mA/cm² to about 120 mA/cm², from about 30 mA/cm² to about 110 mA/cm², from about 30 mA/cm² to about 100 mA/cm². For example, the process may comprise an ammonia producing current density as noted above at a potential vs. RHE of from about −0.2 V to about −2 V, from about −0.2 V to about −1.5 V, from about −0.2 V to about −1 V, from about −0.2 V to about −0.8 V, from about −0.3 V to about −0.8 V, from about −0.4 V to about −0.8 V, from about −0.5 V to about −0.8 V, or from about −0.6 V to about −0.8 V. In other embodiments, the process may comprise an ammonia producing current density as noted above at a potential vs. RHE of about −0.2 or less, about −0.4 or less, about −0.6 or less, about −0.8 or less, or about −1 or less.

In some embodiments, the process comprises a nitrite producing current density of about 5 mA/cm² or less, about 4 mA/cm² or less, about 3 mA/cm² or less, about 2 mA/cm² or less, about 1 mA/cm² or less, about 0.75 mA/cm² or less, about 0.5 mA/cm² or less, or about 0.25 mA/cm² or less.

The nitrate-to-ammonia coulombic efficiency of the process can be calculated by the following formula: CE_{NH}_{₃}=n_{NH}_{₃}*F*C_{NH}_{_{3 measured}}*V/(M_{NH}_{₃}*Q), wherein F is the Faraday constant (96,485 C mol⁻¹); C_{NH}_{_{3 measured}} is the detected concentration of ammonia; V is the volume of the electrolyte; Q is the total charge passing through the electrode (i.e. by integration of CA current); n is the number of electron transfer (8 for ammonia); and M is molecular weight of the molecule (17 g mol⁻¹ for ammonia).

In certain embodiments, the electrochemical conversion process has a coulombic efficiency for nitrate-to-ammonia conversion of about 70% or greater, about 75% or greater, about 80% or greater, about 85% or greater, about 90% or greater, about 91% or greater, about 92% or greater, about 93% or greater, about 94% or greater, about 95% or greater, about 96% or greater, about 97% or greater, about 98% or greater, or about 99% or greater. For example, from about 90% to about 100%, from about 92% to about 100%, from about 94% to about 100%, from about 96% to about 100%, from about 98% to about 100%, from about 99% to about 100%, or from about 99.5% to about 100%.

Similarly, the nitrate-to-nitrite coulombic efficiency of the process can be calculated by the following formula: CE_{NO}_{₂}₋=n_{NO}_{₂}₋*F*C_{NO}_{₂}₋*V/(M_{NO}_{₂}₋*Q), wherein F is the Faraday constant (96,485 C mol⁻¹); CNO₂⁻ measured is the detected concentration of nitrite; V is the volume of the electrolyte; Q is the total charge passing through the electrode (i.e. by integration of CA current); n is the number of electron transfer (2 for nitrite); and M is molecular weight of the molecule (60 g mol⁻¹ for nitrite).

In various embodiments, the electrochemical conversion process has a coulombic efficiency for nitrate-to-nitrite conversion of about 2% or less, about 1.5% or less, about 1% or less, about 0.9% or less, about 0.8% or less, about 0.7% or less, about 0.6% or less, about 0.5% or less, about 0.4% or less, about 0.3% or less, about 0.2% or less, about 0.1% or less, about 0.075% or less, about 0.05% or less, about 0.025% or less, or about 0.01% or less.

### EXAMPLES

### Example 1

A comparison of possible catalyst metals was conducted in a first experiment. A total of sixteen metals were tested, including Zr, Ti, Ta, V, Nb, W, Re, Mo, Fe, Ni, Co, Pt, Pd, Cu, Au, and Ag.

For each tested metal, the experimental set up comprised 150 mL of an electrolytic solution containing 0.1 M KNO₃ and 0.1 M KOH; 4 cm² of the metal-plated electrode (1 cm×2 cm at 2 sides) as the working electrode; 4 cm² of Pt foil (1 cm×2 cm at 2 sides) as the counter electrode; room temperature (20-25° C.); and an Ag/Ag electrode as the reference electrode for potential control. Both the working electrode and the counter electrode were anchored with a stainless steel clamp, the distance between the working electrode and the counter electrode was 1 cm, and the distance between the working electrode and the reference electrode was 1 cm.

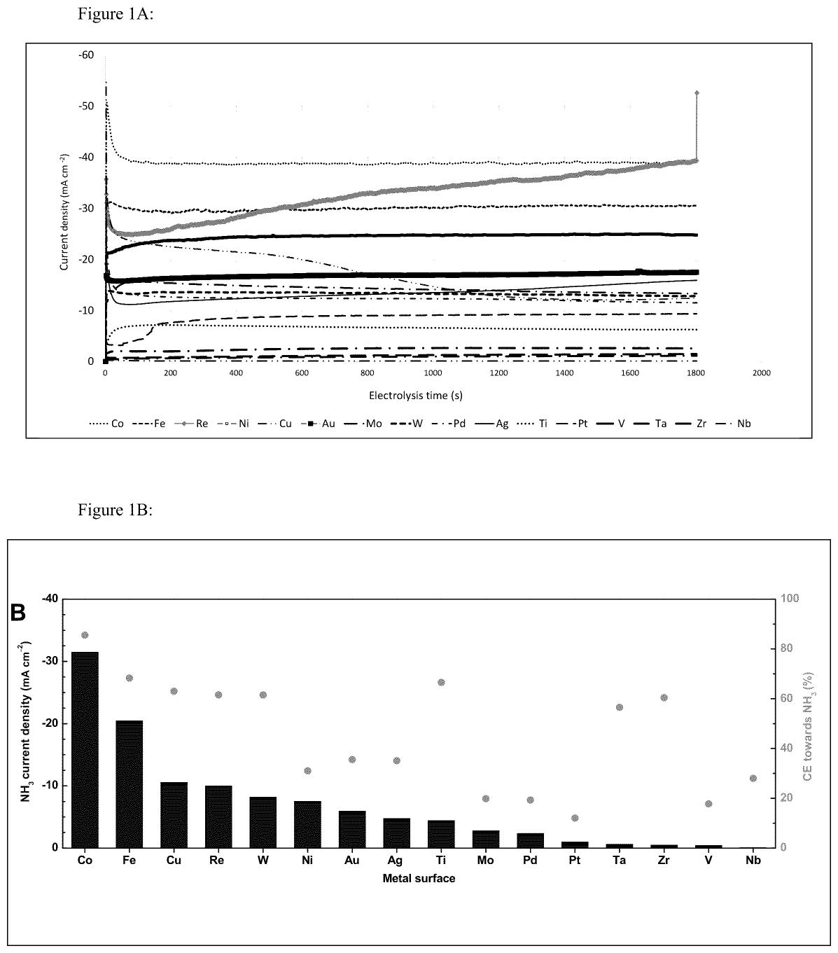

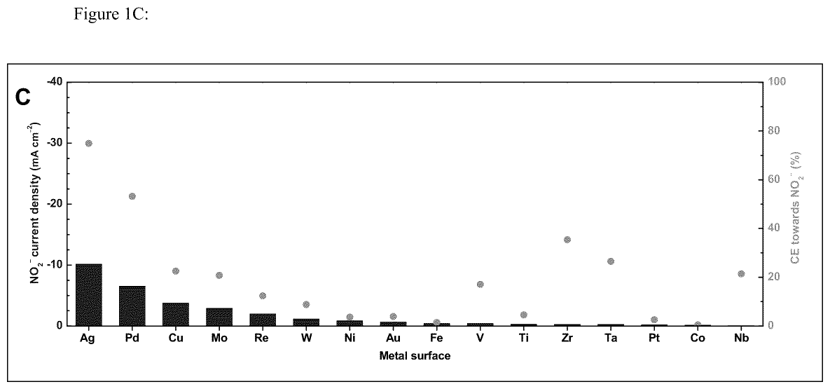

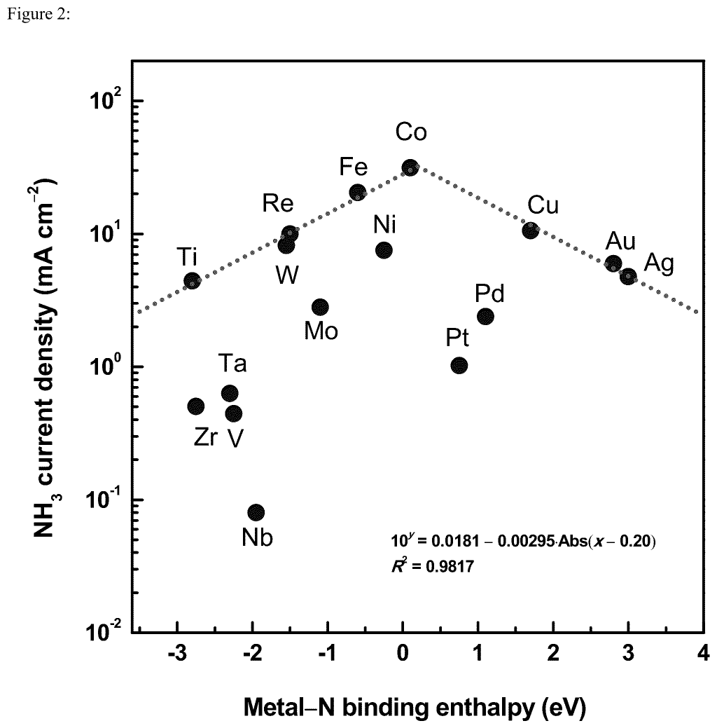

The experiment consisted of the application of a constant potential of −0.500 V vs. RHE (−1.479 V vs. Ag/AgCl) and 30 min of constant-potential operation. The results are set forth in FIG. 1A-1C.

In FIG. 1B, the coulombic efficiency towards ammonia is represented by the data points and the ammonia-producing current density is represented by the bars. Similarly, in FIG. 1C, the coulombic efficiency towards nitrite is represented by the data points and the nitrite-producing current density is represented by the bars. As noted in FIG. 1B, the ammonia-producing current density follows the descending trend: Co, Fe, Cu, Re, W, Ni, Au, Ag, Ti, Mo, Pd, Pt, Ta, Zr, V, and Nb. In addition, Co exhibited highest the coulombic efficiency toward ammonia (86%) and the least production of the nitrite by-product (<0.5%, see FIG. 1C).

The ammonia-producing activity of the catalytic metals were also correlated with the metal-nitrogen binding strength to evaluate the activity of the metal surface of the catalyst. Cobalt was discovered to have the metal-nitrogen binding enthalpy (0.10 eV) that is closest to the optimal value (0.20 eV). The optimal value was obtained from regression of a volcano plot, as shown in FIG. 2.

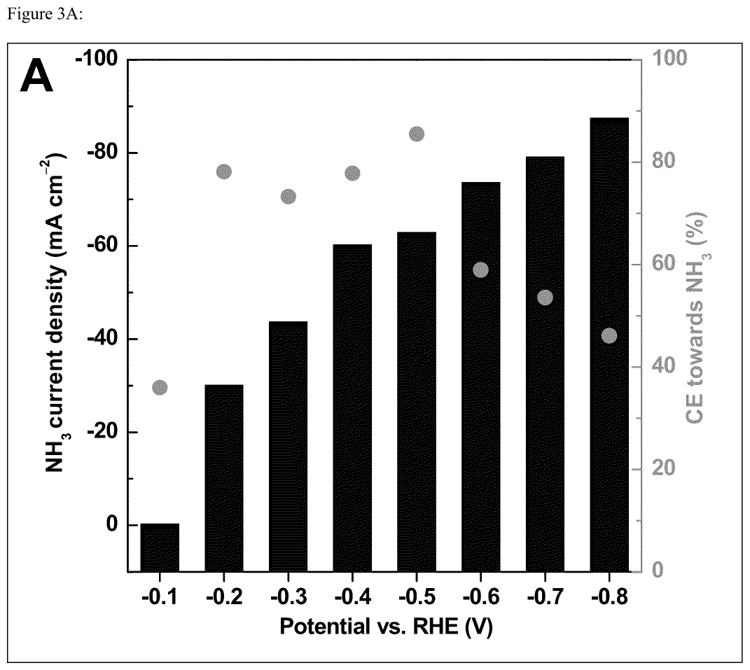

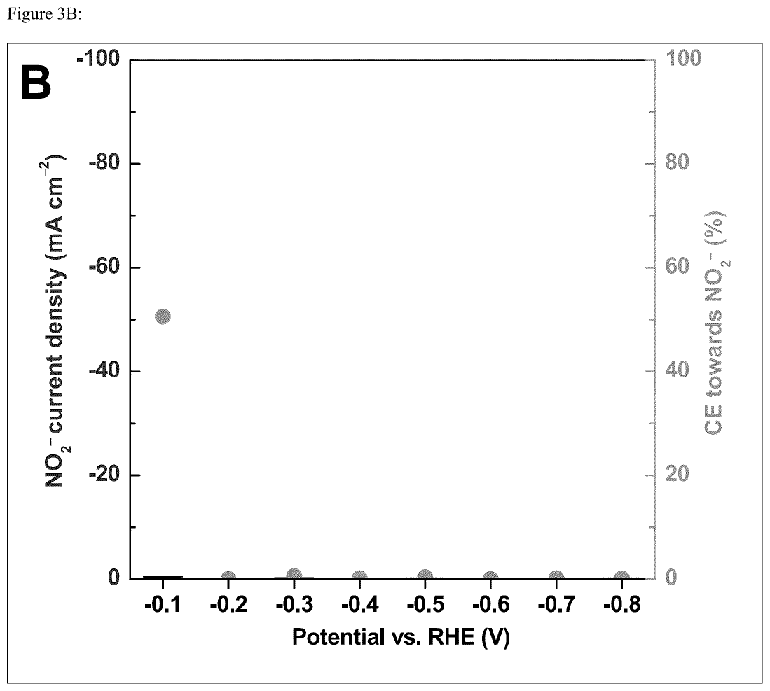

Next, a cobalt foil was tested. FIG. 3 reports the results of nitrate-reduction performance on a foil as a function of the working potential. FIG. 3A reports the ammonia-producing current density and its coulombic efficiency, while FIG. 3B reports the nitrate-producing current density and its coulombic efficiency. In FIG. 3A, the coulombic efficiency towards ammonia is represented by the data points and the ammonia-producing current density is represented by the bars. Similarly, in FIG. 3B, the coulombic efficiency towards nitrite is represented by the data points and the nitrite-producing current density is represented by the bars.

The results demonstrated that cobalt was a surprisingly effective catalyst for the conversion of nitrate to ammonia.

### Example 2

Various cobalt-plating protocols were tested to evaluate the resulting catalyst performance on nitrate-to-ammonia conversion.

Plating protocols P0-P9 all followed the general procedure of: 50 mL of a plating solution containing 0.1 M CoSO₄ and 1 M (NH₄)₂SO₄; room temperature of plating (20-25° C.); stainless steel mesh (1,000 of mesh count per inch) as the plating substrate (i.e. catalyst support); 4 cm² of working electrode area (1 cm×2 cm at two sides); 4 cm² of Pt foil as the counter electrode (1 cm×2 cm at two sides); and an Ag/Ag electrode as the reference electrode for potential control. Both the working electrode and the counter electrode were anchored with stainless steel clamp; the distance between the working electrode and the counter electrode was 1 cm; and the distance between the working electrode and the reference electrode was 1 cm.

Reported below in Table 2 are the differing conditions between plating protocols P0-P9.

TABLE 2

| | | Potential | Potential | |
|---|---|---|---|---|
| Plating | Potential range | increment | duration | Additional |
| protocol # | (V vs. Ag/AgCl) | (mV) | (s) | potential loop |
| P0 | −0.6 → −1.5 | 100 | 30 | |
| P1 | −0.6 → −1.5 | 50 | 30 | |
| P2 | −0.6 → −1.7 | 100 | 30 | |
| P3 | −0.9 → −1.5 | 25 | 30 | |
| P4 | −0.6 → −1.3 | 100 | 30 | |
| P5 | −0.6 → −1.3 | 50 | 30 | |
| P6 | −0.6 → −1.3 | 50 | 60 | |
| P7 | −0.6 → −1.3 | 50 | 30 | 3x (−1.1 → −1.3) |
| P8 | −0.6 → −1.3 | 100 | 10 | |
| P9 | −0.6 → −1.5 | 100 | 20 | |

The catalysts of plating protocols P0-P9, containing a stainless steel with a mesh count of 1,000 plated with cobalt, were then tested to determine their impact on nitrate to ammonia conversion.

The experimental design comprised 150 mL of an electrolytic solution containing 0.5 M KNO₃ and 0.1 M KOH; 4 cm² of a Co-plated electrode (1 cm×2 cm at 2 sides) as the working electrode; 4 cm² of Pt foil (1 cm×2 cm at 2 sides) as the counter electrode; an Ag/Ag electrode as the reference electrode for potential control; a constant potential of −0.300 V vs. RHE (−1.279 V vs. Ag/AgCl); and 30 min of constant-potential operation. Both the working electrode and the counter electrode were anchored with stainless steel clamp; the distance between the working electrode and the counter electrode was 1 cm; and the distance between the working electrode and the reference electrode was 1 cm.

The results are reported below in Table 3.

TABLE 3

| | | | Average | Average Co- | Average |
|---|---|---|---|---|---|
| | Average | | current | normalized | coulombic |
| | maximum | Average | density of | current of | efficiency of |
| | plating current | loading of Co | nitrate | nitrate | nitrate-to- |
| Plating | density | plating | reduction (mA | reduction (mA/ | ammonia |
| protocol # | (mA cm⁻²) | (mg-Co cm⁻²) | cm⁻²) | mg-Co) | conversion |
| P0 | 232 | 3.54 | 158 | 44.6 | 90% |
| P1 | 324 | 5.15 | 160 | 31.1 | |
| P2 | 244 | 2.70 | | | |
| P3 | 325 | 8.70 | 122 | 14.0 | |
| P4 | 122 | 0.81 | 130 | 160.5 | |
| P5 | 121 | 1.50 | 111 | 74.0 | |
| P6 | 183 | 5.44 | 142 | 26.1 | |
| P7 | 235 | 8.31 | 164 | 19.7 | |
| P8 | 217 | 1.08 | 114 | 105.6 | |
| P9 | 246 | 2.33 | 130 | 55.8 | |

### Example 3

An experiment similar to that of Example 2 was conducted to evaluate the impact of differing mesh size of a stainless steel support.

Plating protocol P0 was used as set forth in Example 2. The same procedure for testing the conversion of nitrate to ammonia as set forth in Example 2 was used, except that the constant potential was −0.300 V vs. RHE (−1.279 V vs. Ag/AgCl). The results are set forth below in Table 4.

TABLE 4

| | | | | Average Co- | Average |
|---|---|---|---|---|---|
| | Average | | Average | normalized | coulombic |
| | maximum | Average | current density | current of | efficiency of |
| | plating current | loading of Co | of nitrate | nitrate | nitrate-to- |
| Mesh count | density | plating | reduction (mA | reduction | ammonia |
| (number/inch) | (mA cm⁻²) | (mg-Co cm⁻²) | cm⁻²) | (mA/mg-Co) | conversion |
| 1,000 | 232 | 3.54 | 158 | 44.6 | 90% |
| 500 | 181 | 2.69 | 112 | 46.9 | |
| 325 | 234 | 1.88 | 128 | 68.1 | |
| 200 | 205 | 2.38 | 148 | 62.2 | 90% |
| 100 | 213 | 3.00 | 155 | 51.7 | |
| 60 | 201 | 3.13 | 146 | 46.6 | |
| 40 | 185 | 2.75 | 109 | 39.6 | |

### Example 4

A further experiment was conducted to evaluate the differences in metal mesh support materials.

Plating protocol P0 was used as set forth in Example 2. The same procedure for testing the conversion of nitrate to ammonia as set forth in Example 2 was used. The results are set forth below in Table 5.

TABLE 5

| | | | | Average Co- | Average |
|---|---|---|---|---|---|
| | Average | | Average | normalized | coulombic |
| | maximum | Average | current density | current of | efficiency of |
| | plating current | loading of Co | of nitrate | nitrate | nitrate-to- |
| Metal substrate- | density | plating | reduction (mA | reduction | ammonia |
| mesh count | (mA cm⁻²) | (mg-Co cm⁻²) | cm⁻²) | (mA/mg-Co) | conversion |
| Stainless-steel-200 | 205 | 2.38 | 148 | 62.2 | 90% |
| Monel-400-200 | 204 | 2.25 | 148 | 65.8 | |
| Copper-200 | 222 | 1.25 | 146 | 116.8 | |
| Stainless-steel-100 | 213 | 3.00 | 155 | 51.7 | |
| Nickel-100 | 239 | 2.13 | 113 | 53.1 | |
| Titanium-100 | 184 | 2.13 | 106 | 49.8 | |

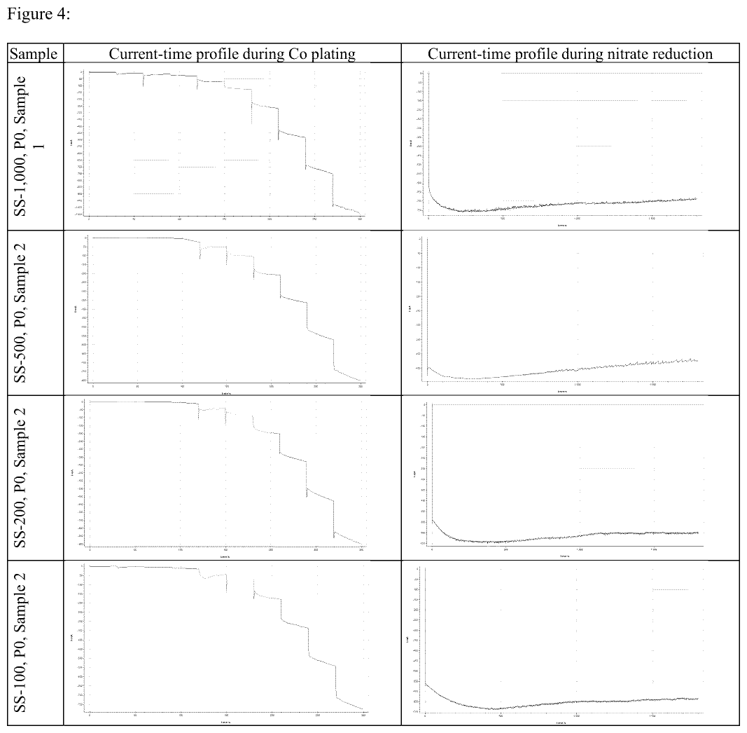

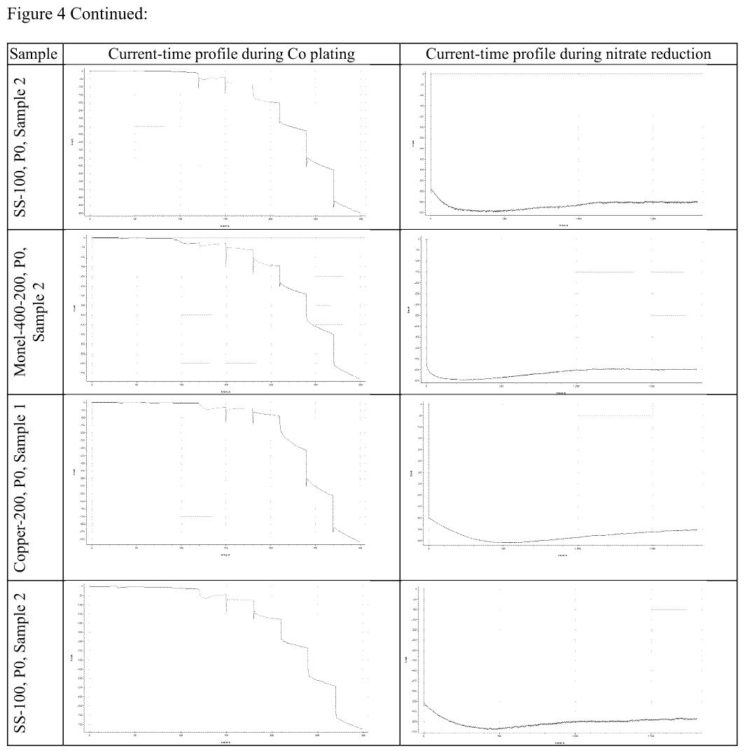

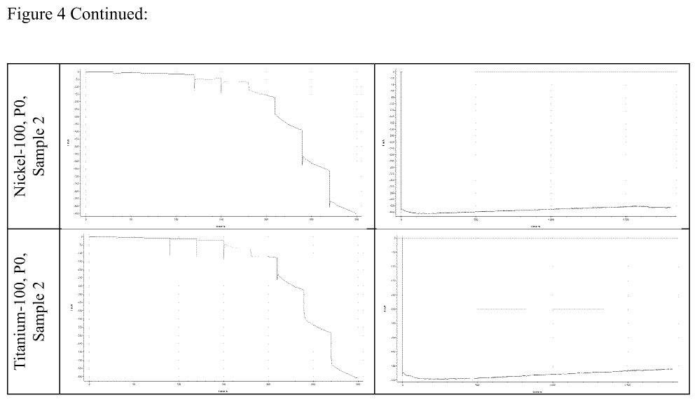

Further testing was conducted to evaluate the PO plating protocol for various catalyst supports. The results are reported below in Table 6. The current-time profiles of the samples noted with an asterisk are set forth in FIG. 4.

TABLE 6

| | | | | Average |
|---|---|---|---|---|
| | | | Maximum | current of |
| | | | plating | nitrate |
| | Sample | Co loading | current | reduction |
| Substrate-mesh count | # | (mg/cm²) | (mA) | (mA) |
| Stainless-steel-1,000 | 1* | 18 | −1,017 | 720 |
| | 2 | 15 | | 550 |
| | 3 | 15 | | |
| | 4 | 16 | | |
| | 5 | 14 | −875 | |
| | 6 | 12 | −925 | |
| | 7 | 9 | −900 | 687 |
| Stainless-steel-500 | 1 | 10 | −773 | 467 |
| | 2* | 13 | −667 | |
| | 3 | 8 | −796 | 440 |
| | 4 | 12 | −653 | 442 |
| Stainless-steel-325 | 1 | 7 | −925 | 540 |
| | 2 | 8 | −950 | 485 |
| Stainless-steel-200 | 1 | 8 | −780 | 567 |
| | 2* | 10 | −861 | 622 |
| | 3 | 10 | −914 | 554 |
| | 4 | 10 | −730 | 620 |
| Stainless-steel-100 | 1 | 12 | −825 | 560 |
| | 2* | 11 | −750 | 650 |
| | 3 | 13 | −928 | 636 |
| | 4 | 12 | −902 | 638 |
| Stainless-steel-60 | 1 | 11 | −863 | 590 |
| | 2 | 14 | −744 | 580 |
| Stainless-steel-40 | 1 | 10 | −690 | 456 |
| | 2 | 12 | −792 | 412 |
| Monel-400-200 | 1 | 10 | −874 | 588 |
| | 2* | 8 | −754 | 592 |
| Copper-200 | 1* | 6 | −925 | 540 |
| | 2 | 4 | −950 | 485 |
| Nickel-100 | 1* | 9 | −921 | 470 |
| | 2 | 8 | −992 | 433 |
| Titanium-100 | 1 | 7 | −650 | 365 |
| | 2* | 10 | −825 | 482 |

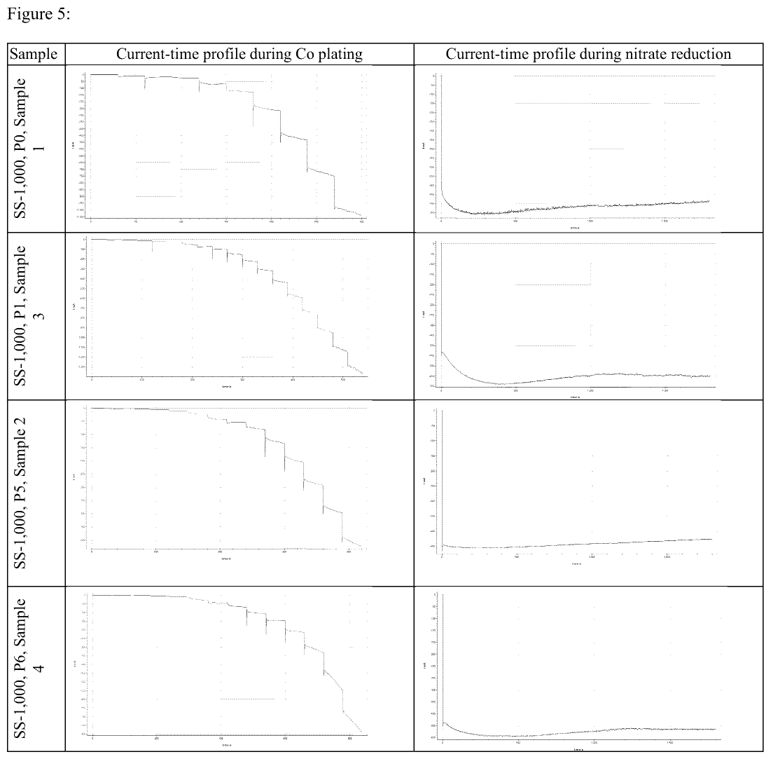

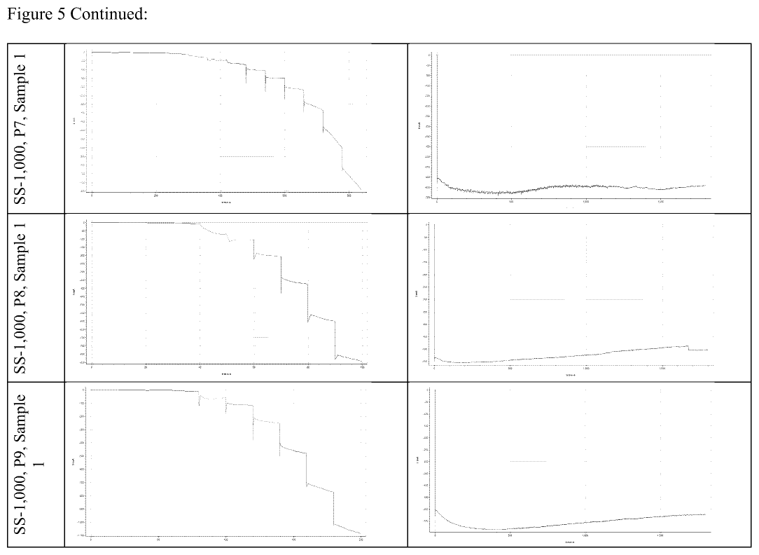

Finally, a test was conducted to evaluate the different plating protocols for a stainless steel 1,000 mesh count support. The results are set forth below in Table 7. The current-time profiles of the samples noted with an asterisk are set forth in FIG. 5.

TABLE 7

| | | Co | Maximum | Average current of |
|---|---|---|---|---|
| Plating | Sample | loading | plating current | nitrate reduction |
| protocol | # | (mg/cm²) | (mA) | (mA) |
| P0 | 1* | 18 | −1,017 | 720 |
| | 2 | 15 | | 550 |
| | 3 | 15 | | |
| | 4 | 16 | | |
| | 5 | 14 | −875 | |
| | 6 | 12 | −925 | |
| | 7 | 9 | −900 | 687 |
| P1 | 1 | 15 | −1,100 | 567 |
| | 2 | 15 | −1,300 | |
| | 3* | 25 | −1,377 | 650 |
| | 4 | 22 | −1,450 | |
| | 5 | 26 | −1,250 | 704 |
| P2 | 1 | 7 | | |
| | 2 | 10 | −1,100 | |
| | 3 | 14 | −800 | |
| | 4 | 3 | −1,000 | |
| | 5 | 20 | −1,000 | |
| P3 | 1 | 36 | −1,154 | |
| | 2 | 25 | −1,215 | |
| | 3 | 39 | −1,400 | 486 |
| | 4 | 36 | −1,310 | |
| | 5 | 28 | −1,423 | |
| P4 | 1 | 6 | −383 | |
| | 2 | 5 | −470 | 518 |
| | 3 | 1 | −640 | |
| | 4 | 1 | −457 | |
| P5 | 1 | 9 | −480 | 444 |
| | 2* | 5 | −509 | |
| | 3 | 4 | −467 | |
| | 4 | 6 | −482 | |
| P6 | 1 | 19 | −682 | 481 |
| | 2 | 25 | −768 | 650 |
| | 3 | 21 | −737 | |
| | 4* | 22 | −744 | 575 |
| P7 | 1* | 38 | −1,000 | 650 |
| | 2 | 36 | −1,095 | |
| | 3 | 30 | −835 | 570 |
| | 4 | 29 | −836 | 753 |
| P8 | 1* | 2 | −823 | 528 |
| | 2 | 3 | −952 | 461 |
| | 3 | 8 | −825 | 381 |
| P9 | 1* | 10 | −1,052 | 561 |
| | 2 | 9 | −920 | 511 |
| | 3 | 9 | −983 | 486 |

### Example 5

A further experiment was conducted wherein the cobalt was coated on a metal mesh support by an air-spraying method comprising cobalt nanoparticles.

The cobalt-coated metal mesh was prepared by air-spraying a cobalt nanoparticle-containing ink onto a 1,000 mesh stainless steel mesh support. The cobalt nanoparticle-containing ink comprised approximately 0.1 g of cobalt nanoparticles (about 28 nm average particle size), 0.66 g of an ionomer composition (Nafion, 5 wt. %), and 1 g of isopropanol. The ink was mixed by ultrasonication at 0° C. for 30 minutes, and then it was uniformly sprayed by an air-sprayer onto the stainless-steel substrate.

The resulting catalysts were then tested for electrochemical conversion of nitrate. The testing protocol was the same as the protocol set forth in Example 2. The results are set forth below in Table 8.

TABLE 8

| | | Average | | Average | |
|---|---|---|---|---|---|
| | Average | coulombic | Average | coulombic | Average |
| | current density | efficiency of | ammonia- | efficiency of | nitrite- |
| | of nitrate | nitrate-to- | producing | nitrate-to- | producing |
| Cobalt loading | reduction (mA | ammonia | current density | nitrite | current density |
| (mg-Co cm⁻²) | cm⁻²) | conversion | (mA cm⁻²) | conversion | (mA cm⁻²) |
| 10.0 | 102 | 90% | 92 | 1.3% | 1.3 |
| 15.1 | 76 | 88% | 66 | 1.4% | 1.1 |

Having described the disclosure in detail, it will be apparent that modifications and variations are possible without departing from the scope of the disclosure defined in the appended claims.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above systems and methods without departing from the scope of the disclosure, it is intended that all matter contained in the above description and shown in the accompanying drawings shall be interpreted as illustrative and not in a limiting sense.

What is claimed is:

1. A process for converting nitrate to ammonia, comprising:
electrochemically converting nitrate in the presence of a catalyst to form a product comprising ammonia;
wherein the catalyst comprises cobalt on a support;
wherein the support comprises a metal and is in a form selected from the group consisting of a foil, mesh, cloth, gauze, sponge, and combinations thereof.

2. The process of claim 1, wherein the catalyst has a cobalt loading of from about 0.75 mg/cm² to about 25 mg/cm², from about 0.75 mg/cm² to about 20 mg/cm², from about 0.75 mg/cm² to about 15 mg/cm², from about 0.75 mg/cm² to about 10 mg/cm², from about 0.8 mg/cm² to about 10 mg/cm², from about 0.85 mg/cm² to about 10 mg/cm², from about 0.9 mg/cm² to about 10 mg/cm², from about 1 mg/cm² to about 10 mg/cm², from about 1 mg/cm² to about 9.5 mg/cm², from about 1 mg/cm² to about 9 mg/cm², from about 1 mg/cm² to about 8.5 mg/cm², from about 1 mg/cm² to about 8 mg/cm², from about 1 mg/cm² to about 7.5 mg/cm², from about 1 mg/cm² to about 7 mg/cm², from about 1 mg/cm² to about 6.5 mg/cm², from about 1 mg/cm² to about 6 mg/cm², from about 1 mg/cm² to about 5.5 mg/cm², from about 1.5 mg/cm² to about 5.5 mg/cm², from about 2 mg/cm² to about 5.5 mg/cm², from about 2.5 mg/cm² to about 5.5 mg/cm², from about 2.5 mg/cm² to about 5 mg/cm², or from about 2.5 mg/cm² to about 4.5 mg/cm².

3. The process of claim 1, wherein the support comprises a metal selected from the group consisting of stainless steel, nickel, copper, a Ni—Cu alloy, titanium, and combinations thereof.

4. The process of claim 1, wherein the support has a mesh count of from about 20 to about 1,000 per inch, from about 20 to about 900 per inch, from about 20 to about 800 per inch, from about 20 to about 700 per inch, from about 20 to about 600 per inch, from about 20 to about 500 per inch, from about 20 to about 400 per inch, from about 30 to about 400 per inch, from about 40 to about 400 per inch, from about 50 to about 400 per inch, from about 60 to about 400 per inch, from about 60 to about 300 per inch, or from about 60 to about 200 per inch.

5. The process of claim 1, wherein the cobalt is deposited on the support using a method selected from the group consisting of electroplating, electrodeposition, chemical plating, air-spraying, solution-brushing, sintering of microparticles or nanoparticles, and combinations thereof.

6. The process of claim 5, wherein the cobalt is deposited on the support using a method comprising electroplating.

7. The process of claim 1, wherein the nitrate is present in a composition comprising KOH, KNO₃, or a combination thereof.

8. The process of claim 7, wherein the nitrate is present in a composition comprising KOH and KNO₃.

9. The process of claim 1, wherein the ammonia producing current density is from about 30 mA/cm² to about 300 mA/cm², from about 30 mA/cm² to about 250 mA/cm², from about 30 mA/cm² to about 200 mA/cm², from about 30 mA/cm² to about 190 mA/cm², from about 30 mA/cm² to about 180 mA/cm², from about 30 mA/cm² to about 170 mA/cm², from about 30 mA/cm² to about 160 mA/cm², from about 30 mA/cm² to about 150 mA/cm², from about 30 mA/cm² to about 140 mA/cm², from about 30 mA/cm² to about 130 mA/cm², from about 30 mA/cm² to about 120 mA/cm², from about 30 mA/cm² to about 110 mA/cm², from about 30 mA/cm² to about 100 mA/cm².

10. The process of claim 1, wherein the process is conducted at a potential vs. RHE of from about −0.2 V to about −2 V, from about −0.2 V to about −1.5 V, from about −0.2 V to about −1 V, from about −0.2 V to about −0.8 V, from about −0.3 V to about −0.8 V, from about −0.4 V to about −0.8 V, from about −0.5 V to about −0.8 V, or from about −0.6 V to about −0.8 V.

11. The process of claim 1, wherein the process is conducted at a potential vs. RHE of about −0.2 or less, about −0.4 or less, about −0.6 or less, about −0.8 or less, or about −1 or less.

12. The process of claim 1, wherein the coulombic efficiency for nitrate-to-ammonia conversion is about 70% or greater, about 75% or greater, about 80% or greater, about 85% or greater, about 90% or greater, about 91% or greater, about 92% or greater, about 93% or greater, about 94% or greater, about 95% or greater, about 96% or greater, about 97% or greater, about 98% or greater, or about 99% or greater.

13. The process of claim 1 wherein the coulombic efficiency for nitrate-to-nitrite conversion is about 2% or less, about 1.5 or less, about 1% or less, about 0.9% or less, about 0.8% or less, about 0.7% or less, about 0.6% or less, about 0.5% or less, about 0.4% or less, about 0.3% or less, about 0.2% or less, or about 0.1% or less.

14. A process for converting nitrate to ammonia, comprising:
electrochemically converting nitrate in the presence of a catalyst to form a product comprising ammonia;
wherein the catalyst comprises cobalt in a form selected from the group consisting of a foil, mesh, cloth, gauze, sponge, and combinations thereof.

15. The process of claim 14, wherein the catalyst comprises about 90% or greater, about 92% or greater, about 94% or greater, about 96% or greater, about 98% or greater, about 99% or greater, or about 99.6% or greater cobalt.

16. The process of claim 14, wherein the catalyst does not comprise a support.

17. The process of claim 14, wherein the nitrate is present in a composition comprising KOH, KNO₃, or a combination thereof.

18. The process of claim 14, wherein the ammonia producing current density is from about 30 mA/cm² to about 300 mA/cm², from about 30 mA/cm² to about 250 mA/cm², from about 30 mA/cm² to about 200 mA/cm², from about 30 mA/cm² to about 190 mA/cm², from about 30 mA/cm² to about 180 mA/cm², from about 30 mA/cm² to about 170 mA/cm², from about 30 mA/cm² to about 160 mA/cm², from about 30 mA/cm² to about 150 mA/cm², from about 30 mA/cm² to about 140 mA/cm², from about 30 mA/cm² to about 130 mA/cm², from about 30 mA/cm² to about 120 mA/cm², from about 30 mA/cm² to about 110 mA/cm², from about 30 mA/cm² to about 100 mA/cm².

19. The process of claim 14, wherein the process is conducted at a potential vs. RHE of from about −0.2 V to about −2 V, from about −0.2 V to about −1.5 V, from about −0.2 V to about −1 V, from about −0.2 V to about −0.8 V, from about −0.3 V to about −0.8 V, from about −0.4 V to about −0.8 V, from about −0.5 V to about −0.8 V, or from about −0.6 V to about −0.8 V.

20. The process of claim 14, wherein the coulombic efficiency for nitrate-to-ammonia conversion is about 70% or greater, about 75% or greater, about 80% or greater, about 85% or greater, about 90% or greater, about 91% or greater, about 92% or greater, about 93% or greater, about 94% or greater, about 95% or greater, about 96% or greater, about 97% or greater, about 98% or greater, or about 99% or greater.
